(19) United States
(12) Patent Application Publication
(10) Pub. No.: US 2015/0093640 A1
(43) Pub. Date: Apr. 2, 2015

(54) ELECTRODE MATERIAL, AND CAPACITOR AND SECONDARY BATTERY USING SAID ELECTRODE MATERIAL

(71) Applicant: SUMITOMO ELECTRIC INDUSTRIES, LTD., Osaka-shi, Osaka (JP)

(72) Inventors: Masatoshi Majima, Itami-shi (JP); Akihisa Hosoe, Osaka-shi (JP); Junichi Nishimura, Osaka-shi (JP); Kazuki Okuno, Osaka-shi (JP); Kotaro Kimura, Osaka-shi (JP); Kengo Goto, Osaka-shi (JP); Hideaki Sakaida, Osaka-shi (JP)

(73) Assignee: SUMITOMO ELECTRIC INDUSTRIES, LTD., Osaka-shi, Osaka (JP)

(21) Appl. No.: 14/387,266

(22) PCT Filed: Mar. 19, 2013
(86) PCT No.: PCT/JP2013/057803

§ 371 Date: Sep. 23, 2014

(30) Foreign Application Priority Data
Mar. 29, 2012 (JP) 2012-076186

(51) Int. Cl. H01G 11/34; H01M 4/40; H01M 4/36; H01G 11/86; H01G 11/50; H01G 11/52; H01G 11/42; H01M 4/134; H01M 4/46

(52) U.S. Cl. CPC H01G 11/34; H01M 4/134; H01M 4/405; H01M 4/366; H01M 4/463; H01G 11/50; H01G 11/52; H01G 11/42; H01G 11/86
USPC 429/220; 429/218.1; 429/231.95; 361/502; 252/182.1

(57) ABSTRACT

An electrode material that is used as an electrode in an electric double layer capacitor, a lithium ion capacitor, and a lithium secondary battery and has a reduced internal resistance for improving output is provided. The electrode material is characterized in that a metal is filled into pores in a surface portion at one surface of a powder molded body containing at least an active material powder and a metal film is formed on the one surface. The electrode material can be formed by performing a plating treatment on the powder molded body.

### TECHNICAL FIELD

The present invention relates to an electrode material for use in an electric double layer capacitor, a lithium ion capacitor, and a lithium secondary battery.

### BACKGROUND ART

In recent years, an electric double layer capacitor and a lithium ion capacitor have drawn attention as energy storage devices.

An electric double layer capacitor has a large capacity among various capacitors and thus has been widely used for memory backup for electronic apparatuses, and high demand has recently been expected also for vehicles such as hybrid vehicles, fueled vehicles, and the like.

Similarly to batteries, electric double layer capacitors include types such as a button type, a cylindrical type, a square type, and the like. A button type is manufactured, for example, by: disposing a separator between a pair of polarizable electrodes, in each of which an activated carbon electrode layer is provided on a current collector, to form an electric double layer capacitor element; putting the electric double layer capacitor element into a metal case together with an electrolyte; and sealing the metal case with a sealing plate and a gasket which insulates the metal case and the sealing plate from each other. A cylindrical type is manufactured by: stacking and winding the pair of polarizable electrodes and the separator to from an electric double layer capacitor element; putting the electric double layer capacitor element into an aluminum case such that the electric double layer capacitor element is impregnated with an electrolytic solution; and sealing the aluminum case with a sealing material. A square type also has the same basic structure as those of a button type and a cylindrical type.

As an electrolytic solution used in this case, a solution obtained by dissolving a metal salt in an organic solvent that is a nonaqueous electrolyte is mainly used similarly to a lithium secondary battery.

Each polarizable electrode used in the electric double layer capacitor is generally produced by applying activated carbon to a current collector that is an aluminum foil, similarly to a lithium secondary battery. As the current collector for forming the polarizable electrode, for example, Patent Literature 1 to 3 disclose various current collectors for a nonaqueous electrolyte electric double layer capacitor. Patent Literature 1 discloses a metallic current collector such as aluminum, stainless, or the like. Patent Literature 2 discloses a current collector obtained by electrically welding a stainless fiber mat to a stainless foil. Patent Literature 3 discloses a net-like current collector formed from at least one metal of tantalum, aluminum, and titanium.

Patent Literature 4 states that an aluminum porous body obtained by performing a conductive treatment on a porous nonwoven fabric and stacking an aluminum-plated layer thereon is used as a current collector. Patent Literature 5 states that an aluminum porous body obtained by performing a conductive treatment on a resin porous body, forming an aluminum-plated layer thereon by molten salt electrolysis, and removing the resin porous body is used as a current collector.

Meanwhile, a lithium ion capacitor is an energy storage device including a positive electrode composed of a polarizable electrode using activated carbon, a negative electrode using, as an electrode material, a material obtained by causing a carbon material such as graphite, which is capable of occluding and releasing lithium ions, to occlude lithium ions, and a nonaqueous electrolytic solution containing a lithium salt as a solute, and has performance having characteristics of a lithium ion secondary battery and an electric double layer capacitor. The lithium ion capacitor is characterized by having a higher power density and a better life characteristic than a lithium ion secondary battery and having a higher energy density than an electric double layer capacitor. The lithium ion capacitor is suitable for high power output application for which a lithium ion secondary battery is not suitable, and is expected to be used in a power source of a hybrid vehicle, etc.

Patent Literature 6 states that in a lithium ion capacitor in which, before charging, lithium ions are previously doped into a negative electrode and/or a positive electrode such that the potential of each of the positive electrode and the negative electrode after the positive electrode and the negative electrode are short-circuited is equal to or lower than 2.0 V, a negative electrode active material is formed from a carbide of an easily-graphitizable carbon precursor, thereby increasing a capacity and an energy density.

In addition, Patent Literature 7 states that each of a current collector of a positive electrode and a current collector of a negative electrode has pores extending through front and back surfaces thereof, the facing area of a lithium ion source and the negative electrode is equal to or larger than 75% of the area of the negative electrode and less than 100% of the area of the negative electrode, and it is made possible to dope lithium ions into the negative electrode without leaving the lithium ion source within a cell, thereby increasing the safety and the quality of a lithium ion capacitor.

Patent Literature 8 states that a nonwoven fabric-like nickel-chromium alloy having a degree of porosity of 80 to 97% is used as a current collector for a positive electrode of a lithium ion capacitor.

Furthermore, researches regarding lithium ion secondary batteries have been actively conducted in various fields since lithium ion secondary batteries can have a high energy density. Patent Literature 5 states that a three-dimensional network aluminum porous body is used as a current collector of a lithium ion secondary battery.

As described above, an electrode obtained by using a three-dimensional network metal porous body as a current collector for an electrode and filling the pores of the porous body with an active material has an increased contact area of the current collector and the active material and thus allows the internal resistance of a battery to be reduced to improve the efficiency of the battery. However, further reduction of the internal resistance is desired.

### CITATION LIST

### Patent Literature

PATENT LITERATURE 1: Japanese Laid-Open Patent Publication No. 11-274012
PATENT LITERATURE 2: Japanese Laid-Open Patent Publication No. 09-232190
PATENT LITERATURE 3: Japanese Laid-Open Patent Publication No. 11-150042
PATENT LITERATURE 4: Japanese Laid-Open Patent Publication No. 2010-10364
PATENT LITERATURE 5: International Publication WO98/033227
PATENT LITERATURE 6: Japanese Laid-Open Patent Publication No. 2006-303118
PATENT LITERATURE 7: Japanese Laid-Open Patent Publication No. 2006-286919
PATENT LITERATURE 8: Japanese Laid-Open Patent Publication No. 2011-181972

### SUMMARY OF INVENTION

### Technical Problem

An object of the present invention is to provide an electrode material that is used in an electric double layer capacitor, a lithium ion capacitor, and a lithium ion secondary battery and has a reduced internal resistance for improving the output of an electric double layer capacitor, a lithium ion capacitor, and a lithium ion secondary battery.

### Solution to Problem

(1) An electrode material in which a metal is filled into pores in a surface portion at one surface of a powder molded body containing at least an active material powder and a metal film is formed on the one surface.

(2) The electrode material according to (1), wherein the metal in the pores and the metal film on the one surface are formed by performing a plating treatment on the powder molded body.

(3) An electric double layer capacitor comprising a positive electrode, a negative electrode, a separator located between the positive electrode and the negative electrode, and an electrolytic solution, wherein each of the positive electrode and the negative electrode is composed of the electrode material according to (1) or (2) in which activated carbon is used as the active material powder.

(4) The electric double layer capacitor according to (3), wherein the metal in each of the positive electrode and the negative electrode is aluminum.

(5) A lithium ion capacitor comprising a positive electrode, a negative electrode, a separator located between the positive electrode and the negative electrode, and an electrolytic solution, wherein the positive electrode is composed of the electrode material according to (1) or (2) in which activated carbon is used as the active material powder, and the negative electrode is composed of the electrode material according to claim 1 or 2 in which a material capable of occluding and releasing lithium ions is used as the active material powder.

(6) The lithium ion capacitor according to (5), wherein the active material of the negative electrode is caused to occlude lithium ions in advance.

(7) The lithium ion capacitor according to (5) or (6), wherein the metal in the positive electrode is aluminum and the metal in the negative electrode is copper.

(8) A lithium secondary battery comprising a positive electrode, a negative electrode, a separator located between the positive electrode and the negative electrode, and an electrolytic solution, wherein each of the positive electrode and the negative electrode is composed of the electrode material according to (1) or (2) in which a material capable of occluding and releasing lithium ions is used as the active material powder.

(9) The lithium ion secondary battery according to (8), wherein the metal in the positive electrode is aluminum, and the metal in the negative electrode is copper.

(10) The lithium secondary battery according to (8), wherein both the metal in the positive electrode and the metal in the negative electrode are aluminum.

### Advantageous Effects of Invention

According to the present invention, it is possible to reduce an internal resistance, and thus it is possible to improve output.

### BRIEF DESCRIPTION OF DRAWINGS

FIG. 1 is a diagram showing a basic configuration of a capacitor.

FIG. 2 is a diagram schematically showing a cross section of an electrode material according to the present invention.

### DESCRIPTION OF EMBODIMENTS

An electrode obtained by using a three-dimensional network metal porous body as a current collector and filling the pores of the porous body with an active material for an electrode (hereinafter, referred to as “active material”) has an increased contact area of the current collector and the active material and thus allows an internal resistance to be reduced to improve output. In addition, the circulation of an electrolytic solution is improved, thus it is possible to prevent concentration of a current, and it is possible to improve the reliability of a capacitor and a battery.

However, the three-dimensional network metal porous body is obtained, for example, by using a urethane foam as a base material, forming a metal film on the surface thereof, and then removing the base material. As the urethane foam, a urethane foam having a cell diameter of 400 to 500 μm is generally used. Therefore, the diameters of cells formed by the skeleton of a porous metal obtained by forming a metal film on the surface of the urethane foam are also about 400 to 500 μm.

Meanwhile, the active material filled in the cells of the metallic porous body is equal to or smaller than 20 μm in particle diameter, thus a large number of particles of the active material are filled in a single cell, and the distance between the skeleton of the cell and particles of the active material at and near the center of the cell is large. Therefore, the internal resistance is increased, and the output is not improved.

Presence of a conduction aid such as acetylene black within the cells together with the active material allows the internal resistance to be reduced, but its effect is not sufficient.

An electrode material according to the present invention solves the above-described problems by not using a three-dimensional network metal porous body. In the electrode material according to the present invention, a plating treatment is performed on, as a base material, a powder molded body containing at least an active material powder thereby to fill a metal into pores in a surface portion at one surface of the powder molded body and to form a metal film having a predetermined thickness on the one surface of the powder molded body, and the metal film is used as a current collector, whereby electric contact between the current collector and the active material is improved, and thus it is possible to reduce an internal resistance.

In addition, since the electrode material according to the present invention does not use a three-dimensional network metal porous body, it is possible to reduce the material cost; and since it is possible to integrate the current collector with an electrode, it is possible to reduce the cost of assembling a battery.

Hereinafter, the present invention will be described mainly with an electrode material for an electric double layer capacitor and an electrode material for a lithium ion capacitor as examples. It should be noted that regarding a lithium ion secondary battery, only an active material of an electrode material is different, and as a method for producing the electrode material, a method for producing the electrode material for an electric double layer capacitor and the electrode material for a lithium ion capacitor described below can be used.

Hereinafter, an electric double layer capacitor is also referred to as “EDLC”, and a lithium ion capacitor is also referred to as “LIC”.

[Electric Double Layer Capacitor]

(Structure of Electric Double Layer Capacitor)

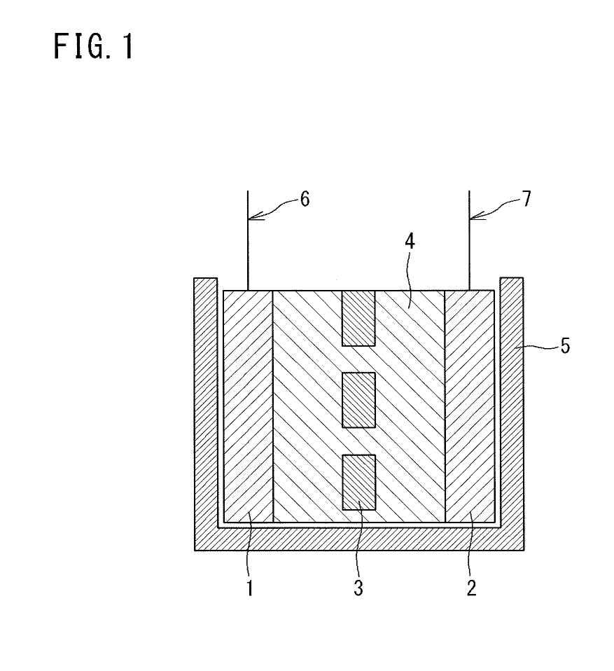

FIG. 1 shows a basic configuration of the electric double layer capacitor (the same applies to a lithium ion capacitor).

A positive electrode 1 and a negative electrode 2 each of which is an electrode material containing an active material are disposed in an organic electrolytic solution 4 partitioned with a separator 3. The positive electrode 1 is connected to a lead wire 6, the negative electrode 2 is connected to a lead wire 7, and all these components are housed in a case 5.

In the electric double layer capacitor, activated carbon is used as the positive electrode active material and the negative electrode active material. In addition, as a metal to be plated, Al is preferably used for both the positive electrode and the negative electrode.

Hereinafter, the electrode material and the electric double layer capacitor according to the present invention will be described in detail.

(Active Material)

As the active material of each electrode for the electric double layer capacitor, activated carbon is used for both the positive electrode and the negative electrode.

As the activated carbon, commercially available activated carbon for an electric double layer capacitor may be used.

Examples of the material of the activated carbon include wood, palm shell, pulping waste liquor, coal and petroleum heavy oil or coal and petroleum pitches obtained by thermally decomposing them, and further resins such as a phenol resin. The above material is generally activated after being carbonized, and examples of an activating method include a gas activation method and a chemical activation method. The gas activation method is a method for obtaining activated carbon by causing a catalytic reaction with water vapor, carbon dioxide gas, oxygen, or the like at a high temperature. The chemical activation method is a method for obtaining activated carbon by impregnating the material with a publicly known activating chemical and heating the material in an inert-gas atmosphere to cause dehydration and oxidation reactions of the activating chemical. Examples of the activating chemical include zinc chloride and sodium hydroxide.

The particle diameter of the activated carbon is not limited but is preferably not larger than about 20 μm. The specific surface area of the activated carbon is also not limited but is preferably about 800 to 3000 m²/g. When the particle diameter and the specific surface area are within these ranges, it is possible to increase the capacity of the capacitor, and it is possible to reduce the internal resistance of the capacitor.

(Conduction Aid)

The electrode material may contain a conduction aid according to needs.

The conduction aid is not limited, and a publicly known or commercially available conduction aid may be used. Examples of the conduction aid include acetylene black, Ketjen Black, carbon fibers, natural graphite (flaky graphite, earthy graphite, etc.), artificial graphite, and ruthenium oxide. Among them, acetylene black, Ketjen Black, carbon fibers, etc. are preferred. Thus, it is possible to improve the conductive property of the capacitor. The amount of the conduction aid is not limited, but the amount of the conduction aid per 100 parts by weight of the activated carbon is preferably about 0.1 to 10 parts by weight and more preferably 0.2 to 5 parts by weight. If the amount of the conduction aid exceeds 10 parts by weight, there is a concern that a capacitance is decreased.

(Binder)

A binder is not limited, and a publicly known or commercially available binder may be used. Examples of the binder include polyvinylidene fluoride, polytetrafluoroethylene, polyvinyl pyrrolidone, polyvinyl chloride, polyolefin, styrene-butadiene rubber, polyvinyl alcohol, and carboxymethyl cellulose.

The amount of the binder is not limited, but the amount of the binder per 100 parts by weight of the activated carbon is preferably 0.2 to 10 parts by weight and more preferably 0.5 to 5 parts by weight. When the amount of the binder is within this range, it is possible to enhance binding strength while preventing an increase in electrical resistance and a decrease in discharge capacity.

(Molding of Powder Molded Body Containing Active Material)

—Molding Mixture—

The electrode material according to the present invention is obtained by performing a plating treatment on the powder molded body containing the active material.

For this, first, a molding mixture containing the active material is prepared for producing the powder molded body.

For producing the powder molded body, a conduction aid or a binder are added to the active material according to needs, and an organic solvent or water is mixed to this mixture, to prepare a molding mixture.

Examples of the organic solvent used in preparing the molding mixture include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, and N-methyl-2-pyrrolidone. In addition, when water is used as a solvent, a surfactant may be used for enhancing filling performance.

The binder may be mixed together with a solvent in forming the molding mixture, but the binder may be dispersed or dissolved in the solvent in advance. For example, a water-based binder such as a fluororesin aqueous dispersion obtained by dispersing a fluororesin in water and a carboxymethyl cellulose aqueous solution; an NMP solution of PVDF used generally when a metal foil is used as a current collector; or the like may be used.

—Molding—

The molding mixture is molded into a sheet shape by compression molding, extrusion molding, or the like, and then the solvent is removed, to obtain a powder molded body. A heat treatment may be performed according to needs. By performing the heat treatment, the binder is melted and the strength of the powder molded body is increased. In addition, a powder molded body can be obtained also by a method in which: a slurry of the molding mixture is applied onto a base sheet; a heat treatment is performed; and then the base sheet is peeled off.

The temperature of the heat treatment is not lower than 80° C. and preferably 100° C. to 200° C.

The pressure at the heat treatment may be ordinary pressure or may be reduced, but the heat treatment is preferably performed under reduced pressure. The pressure when the heat treatment is performed under reduced pressure is, for example, not higher than 1000 Pa and preferably 1 to 500 Pa.

The time period of the heating is determined as appropriate in accordance with the heating atmosphere, the pressure, or the like, but is generally 1 to 20 hours and is preferably 5 to 15 hours.

(Production of Electrode Material)

The powder molded body obtained above is used as a base material, and a plating treatment is performed on the powder molded body.

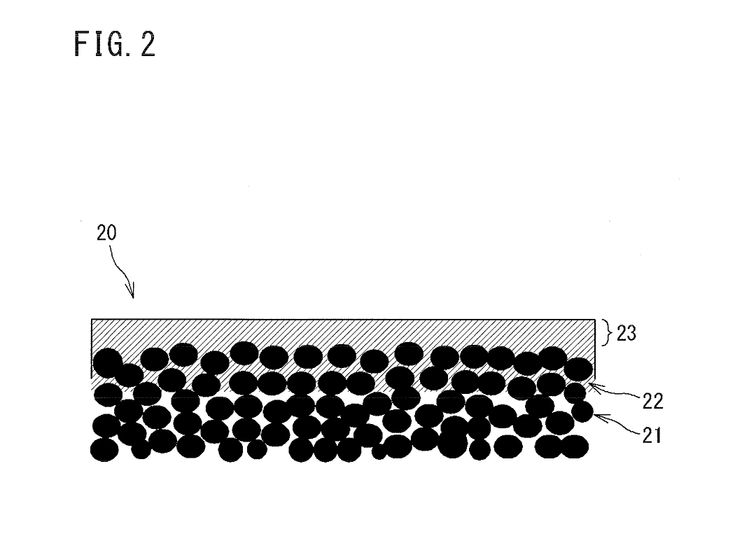

FIG. 2 schematically shows a cross section of an electrode 20 obtained by performing a plating treatment on a powder molded body containing an active material 21. By performing the plating treatment, a metal 22 is filled into pores in a surface portion at one surface of the powder molded body and also a metal film 23 is formed on the one surface of the powder molded body, thereby producing a positive electrode or a negative electrode.

When the metal film 23 is formed on the surface of the powder molded body so as to have a certain film thickness, the metal film 23 functions as a current collector.

At that time, it is necessary to plate only one surface of the powder molded body. For this, a method in which an anode for plating is disposed only at a side where plating is desired and plating is performed without stirring a plating liquid, or a method in which a side of the powder molded body where plating is not desired is sealed according to needs, is effective. A film of a metal other than aluminum can be produced by a general water-based plating method. However, it is difficult to produce a film of aluminum by a water-based plating method, and a film of aluminum can be formed by using a method of plating using a molten salt bath as described in International Publication WO2011/118460.

Hereinafter, molten salt plating will be described.

(Molten Salt Plating)

A DC current is applied in a molten salt with the powder molded body as a cathode and aluminum having a purity of 99.0% as an anode. As the molten salt, an organic molten salt which is a eutectic salt of an organic halide and an aluminum halide or an inorganic molten salt which is a eutectic salt of an alkali metal halide and an aluminum halide may be used. Use of an organic molten salt bath which melts at a relatively low temperature is preferred since the decomposition of a binder resin included in the powder molded body is not caused. As the organic halide, an imidazolium salt, a pyridinium salt, or the like may be used, and specifically, 1-ethyl-3-methylimidazolium chloride (EMIC) and butylpyridinium chloride (BPC) are preferred.

Contamination of the molten salt with water or oxygen causes degradation of the molten salt, and thus plating is preferably performed in an inert-gas atmosphere, such as nitrogen or argon, and in a sealed environment.

As the molten salt bath, molten salt baths containing nitrogen are preferred, and among them, an imidazolium salt bath is preferably used. The imidazolium salt bath is preferred since it allows plating to be performed at a relatively low temperature. As the imidazolium salt, a salt containing an imidazolium cation having alkyl groups at 1,3-positions is preferably used, and particularly, an aluminum chloride+1-ethyl-3-methylimidazolium chloride (AlCl₃+EMIC)-based molten salt is most preferably used since it has high stability and is unlikely to decompose. The temperature of the molten salt bath is 10° C. to 60° C. and preferably 25° C. to 45° C. With a decrease in temperature, the current density range where plating is possible is narrowed, and plating becomes difficult. If the temperature exceeds 60° C., there is the possibility that the binder resin in the powder molded body decomposes. Thus, the temperature is preferably not higher than 60° C.

(Separator)

As the separator, a publicly known or commercially available separator may be used. For example, an insulating film formed from polyolefin, polyethylene terephthalate, polyamide, polyimide, cellulose, glass fibers, or the like is preferred. The average pore diameter of the separator is not particularly limited and is generally about 0.01 to 5 μm, and the average thickness of the separator is generally about 10 to 150 μm.

(Electrolytic Solution)

As the electrolytic solution, a publicly known or commercially available electrolytic solution may be used, and both a nonaqueous electrolytic solution and an aqueous electrolytic solution may be used. Examples of the nonaqueous electrolytic solution include a propylene carbonate solution having tetraalkylphosphonium tetrafluoroborate dissolved therein, a propylene carbonate solution or a sulfolane solution having tetraalkylammonium tetrafluoroborate dissolved therein, and a propylene carbonate solution having triethylammonium tetrafluoroborate dissolved therein. Examples of the aqueous electrolytic solution include alkaline aqueous solutions such as a potassium hydroxide aqueous solution and a sodium hydroxide aqueous solution. Among them, the nonaqueous electrolytic solution is preferred in the present invention. When such an electrolytic solution is used, it is possible to increase the capacitance.

(Production of Electric Double Layer Capacitor)

The separator is interposed between the positive electrode and the negative electrode obtained by performing the plating treatment, and the positive electrode, the negative electrode, and the separator are impregnated with the electrolytic solution, to obtain the electric double layer capacitor according to the present invention.

[Lithium Ion Capacitor]

(Structure of Lithium Ion Capacitor)

The lithium ion capacitor according to the present invention is obtained by: disposing a separator between a pair of electrode materials composed of a positive electrode and a negative electrode; and further impregnating the electrode materials and the separator with an electrolytic solution.

(Positive Electrode Active Material)

As an active material of the positive electrode for the lithium ion capacitor, activated carbon that is the same as that used as the active material of each electrode for the electric double layer capacitor may be used.

(Negative Electrode Active Material)

As an active material of the negative electrode, a negative electrode active material containing, as a main component, a metal capable of occluding and releasing lithium ions (e.g., graphite, lithium titanium oxide (Li₄Ti₅O₁₂)) may be used. Aluminum is used as a plating metal for the positive electrode, Cu is used as a plating metal for the negative electrode, and the negative electrode active material is caused to occlude lithium ions, whereby the potential of the negative electrode is decreased and it is possible to increase a cell voltage. The energy of a capacitor is proportional to the square of a voltage, and thus a capacitor having high energy can be obtained.

Examples of a method for causing the negative electrode active material to occlude lithium include a method in which the negative electrode is immersed in an electrolytic solution in a state of being in contact with a required amount of a lithium metal and is heated to occlude lithium ions, and a method in which the negative electrode and a lithium metal are opposed to each other across a separator and charging is performed with a constant current in an electrolytic solution to occlude lithium ions.

In the present invention, lithium ions are used as electric charge by a nonaqueous electrolytic solution containing a lithium salt, and thus there is a risk of dendrite growth or short circuit due to deposition of lithium. Thus, regarding an amount of lithium ions occluded by the negative electrode, the sum of an amount of lithium ions occluded in advance and an amount of lithium ions to be charged needs to be equal to or smaller than an amount occludable by the negative electrode.

(Conduction Aid)

Each of the positive electrode and the negative electrode may contain a conduction aid according to needs.

As the conduction aid, a conduction aid that is the same as that described for the electric double layer capacitor may be used.

(Binder)

As a binder, a binder that is the same as that described for the electric double layer capacitor may be used.

(Molding of Powder Molded Body for Positive Electrode and Powder Molded Body for Negative Electrode Containing Active Material)

A powder molded body for the positive electrode of the lithium ion capacitor and a powder molded body for the negative electrode of the lithium ion capacitor can be molded in the same manner as described for production of the electrode material for the electric double layer capacitor.

(Production of Electrode Material)

The positive electrode and the negative electrode of the lithium ion capacitor can be produced by performing a plating treatment on the above-obtained powder molded body for the positive electrode and the above-obtained powder molded body for the negative electrode in the same manner as described for production of the electrode material of the electric double layer capacitor.

(Separator)

As the separator, a separator that is the same as that described for the electric double layer capacitor may be used.

(Electrolytic Solution)

As an electrolytic solution for the negative electrode, an electrolytic solution obtained by dissolving a lithium salt required for charging and discharging in an organic solvent may be used.

For example, LiClO₄, LiBF₄, LiPF₆, or the like may be used as the lithium salt. Each of them may be used solely, or any two or more of them may be mixed and used.

As the solvent in which the lithium salt is dissolved, for example, one or more solvents selected from ethylene carbonate, propylene carbonate, butylene carbonate, dimethyl carbonate, diethyl carbonate, and ethyl methyl carbonate can be preferably used.

In particular, preferably, LiPF₆ is used as the lithium salt, and a mixed solution of ethylene carbonate and diethyl carbonate is used as the solvent. If so, the ion conductivity of the electrolytic solution is increased, and it is possible to reduce the internal resistance of the capacitor.

(Production of Lithium Ion Capacitor)

The lithium ion capacitor according to the present invention is obtained by: interposing the separator between the positive electrode and the negative electrode obtained by performing the plating treatment; and impregnating the positive electrode, the negative electrode, and the separator with the electrolytic solution.

### EXAMPLES

Hereinafter, examples of the electrode material for the lithium ion secondary battery according to the present invention will be described. However, these examples are illustrative, the present invention is not limited in any way by these examples, the scope of the present invention is defined by the scope of the claims, and all modifications which fall within the scope of the claims and the equivalents thereof are included therein.

### Example 1

### Production of EDLC Positive Electrode 1

—Production of Powder Molded Body for Positive Electrode—

Ethanol was added to a mixture including 80 mass % of an activated carbon powder (a specific surface area: about 2200 m²/g, average particle diameter: about 6 μm), 10 mass % of Ketjen Black as a conduction aid, and 10 mass % of PTFE, and the mixture was kneaded and was rolled into a sheet having a width of 10 cm, a length of 10 cm, and a thickness of 1.2 mm. Next, the sheet was dried at 200° C. for 2 hours to obtain a “powder molded body 1 for an EDLC positive electrode”.

—Molten Salt Plating—

The “powder molded body 1 for an EDLC positive electrode” obtained above was set as a workpiece to a jig having a power supply function. Then, the jig was put into a glove box whose interior had been kept under an argon atmosphere and at a low moisture (dew point: −30° C. or lower), and was immersed in a molten salt aluminum plating bath (33 mol % EMIC-67 mol % AlCl₃) at a temperature of 40° C. The jig to which the workpiece had been set was connected to the cathode side of a rectifier, and an aluminum plate (purity: 99.99%) that is a counter electrode was connected to the anode side of the rectifier. At that time, the aluminum plate that is a counter electrode was disposed only at a side where plating was desired, such that a plating was formed only on one surface of the “powder molded body 1 for an EDLC positive electrode”, and plating was performed without stirring a plating liquid.

The plating treatment was performed by applying a direct current having a current density of 3.6 A/dm² for 90 minutes, to obtain an “EDLC positive electrode 1”. Stirring of the plating bath was performed with a stirrer using a Teflon (registered trademark) rotor.

When a cross section of the obtained “EDLC positive electrode 1” was observed, an aluminum metal was filled in pores in a surface portion at the one surface of the powder molded body, and an aluminum film having a film thickness of 20 μm was formed on the one surface of the powder molded body.

### Example 2

### Production of EDLC Negative Electrode 1

An “EDLC negative electrode 1” was produced by the same production method as for the “EDLC positive electrode 1”.

### Example 3

### Production of LIC Positive Electrode 1

An “LIC positive electrode 1” was produced by the same production method as for the “EDLC positive electrode 1”.

When a cross section of the obtained “LIC positive electrode 1” was observed, an aluminum metal was coated on the surfaces of the active material and the solid electrolyte at the side where there is the aluminum plate that is a counter electrode, and an aluminum film having a film thickness of 5 μm was formed on the outermost surface of the powder molded body.

### Example 4

### Production of LIC Negative Electrode 1

—Production of Powder Molded Body for Negative Electrode—

A graphite powder having an average particle diameter of 10 μm was prepared as an active material, and the graphite powder, PTFE, and Ketjen Black (a conduction aid) were mixed at a ratio of 80:10:10 in mass %. Ethanol was added dropwise to the mixture, to prepare a powder mixture for a negative electrode powder molded body. The powder mixture was rolled into a sheet having a width of 10 cm, a length of 10 cm, and a thickness of 1.2 mm. Next, the sheet was dried at 200° C. for 2 hours, to obtain a “powder molded body 1 for an LIC negative electrode”.

—Copper Plating—

The “powder molded body 1 for an LIC negative electrode” was immersed into a publicly known copper sulfate plating bath, and electroplating was performed. In the bath composition, copper sulfate was set at 200 g/L, and sulfuric acid was set at 50 g/L. A copper plate containing phosphorus was used as a counter electrode. At that time, the copper plate that is a counter electrode was disposed only at a side where plating was desired, such that a plating was formed only on one surface of the “powder molded body 1 for an LIC negative electrode”, and plating was performed without stirring a plating liquid.

In the obtained “LIC negative electrode 1”, copper was coated on the activated carbon surface at a side where there is the copper plate that is a counter electrode, and an aluminum film having a film thickness of 5 μm was formed on the outermost surface of the powder molded body.

### Example 5

### Production of Electric Double Layer Capacitor 1

The “EDLC positive electrode 1” and the “EDLC negative electrode 1” were dried at 180° C. under reduced pressure for 5 hours. Each of the “EDLC positive electrode 1” and the “EDLC negative electrode 1” was cut into 3 cm×3 cm, and a tab lead was connected thereto. Surfaces of these electrodes where no plating film was formed were opposed to each other, and a separator formed from cellulose fibers (thickness: 40 μm, density: 0.45 g/cm³, degree of porosity: 70%) was disposed therebetween. Next, the stacked body was put into an aluminum laminate bag, and the electrodes and the separator were impregnated with a nonaqueous electrolytic solution (a propylene carbonate solution having tetraethylphosphonium tetrafluoroborate dissolved in 1 mol/l therein). Furthermore, the pressure in the cell was reduced and the cell was sealed, to produce an “electric double layer capacitor 1” for a test. A rated voltage was set at 2.5 V.

Ten electric double layer capacitors having the same specifications were produced in total by the same method.

### Example 6

### Production of Lithium Ion Capacitor 1

The “LIC positive electrode 1” and the “LIC negative electrode 1” were dried at 180° C. under reduced pressure for 5 hours. Each of the “LIC positive electrode 1” and the “LIC negative electrode 1” was cut into 3 cm×3 cm, and a tab lead was connected thereto. Surfaces of these electrodes where no plating film was formed were opposed to each other, and a separator formed from cellulose fibers (thickness: 40 μm, density: 0.45 g/cm³, degree of porosity: 70%) was disposed therebetween. Next, the “LIC negative electrode 1” and a lithium metal foil having a thickness of 10 μm to which a tab lead was connected were opposed to each other, and a separator formed from a polyolefin resin (thickness: 20 μm, degree of porosity: 50%) was disposed therebetween. The stacked body was put into an aluminum laminate bag, and a nonaqueous electrolytic solution (an electrolytic solution having LiPF₆ dissolved in 1 mol/L therein which was obtained by mixing ethylene carbonate (EC) and diethyl carbonate (DEC) at a volume ratio of 1:1) was injected thereinto to impregnate the electrodes and the separator with the nonaqueous electrolytic solution. The pressure in the cell was reduced and the cell was sealed, to produce a “lithium ion capacitor 1” for a test.

Ten lithium ion capacitors having the same specifications were produced in total by the same method.

### Comparative Example 1

An aluminum foil (thickness: 25 μm) was used as a current collector. A conductive adhesive was applied to a surface of each of the above-described “powder molded body 1 for an EDLC positive electrode” and the above-described “powder molded body 1 for an EDLC negative electrode”, and the aluminum foil was attached to each surface to obtain an “EDLC positive electrode 2” and an “EDLC negative electrode 2”.

Next, an “electric double layer capacitor 2” was produced in the same manner as in Example 5, except that these electrodes were used.

### Comparative Example 2

An aluminum foil (thickness: 25 μm) was used as a current collector for a positive electrode, and a copper foil (thickness: 25 μm) was used as a current collector for a negative electrode. The aluminum foil and the copper foil were attached to a surface of the above-described “powder molded body 1 for an LIC positive electrode” and a surface of the above-described “powder molded body 1 for an LIC negative electrode”, respectively, by using a conductive adhesive, to obtain an “LIC positive electrode 2” and an “LIC negative electrode 2”.

Next, a “lithium ion capacitor 2” was produced in the same manner as in Example 6, except that these electrodes were used.

<Evaluation of Capacitance>

The capacitors and the lithium ion capacitors of Example 5 and 6 and Comparative Examples 1 and 2 were charged at 2 mA/cm² for 2 hours and were discharged at 1 mA/cm², and an initial capacitance and the range of a charging voltage/an operating voltage were examined. The averages of them are shown in Table 1.

TABLE 1

| | Capacitance | Charging |
|---|---|---|
| | (F) | voltage (V) |
| Example 5 | 13.2 | 2.5 |
| Example 6 | 13.4 | 4 |
| Comparative | 7.5 | 2.5 |
| Example 1 | | |
| Comparative | 7.8 | 4 |
| Example 2 | | |

As is obvious from Table 1, the capacitors of Examples 5 and 6 have a higher capacitance than the capacitors of Comparative Examples 1 and 2 using the Al foil, and thus are able to improve their energy density.

<Durability Test>

As a durability test method, a charging and discharging cycle characteristic was examined. The cycle characteristic is an important index representing the life of a cell. A charging and discharging cycle was repeated at an atmospheric temperature of 45° C. with a constant current of 1 mA between 0.5 to 3.0V as conditions ten thousand times, and a discharge capacity after ten thousand cycles was measured and compared to an initial capacity for evaluation. The results are shown in Table 2.

TABLE 2

| | Capacitance (F) | | |
|---|---|---|---|
| | | After ten | Maintenance |
| | Initial | thousand cycles | ratio (%) |
| Example 5 | 13.2 | 12.5 | 94.7 |
| Example 6 | 13.4 | 12.6 | 94.0 |
| Comparative | 7.5 | 6.9 | 92.0 |
| Example 1 | | | |
| Comparative | 7.8 | 7.2 | 92.0 |
| Example 2 | | | |

As is obvious from Table 2, in the capacitors of Examples 5 and 6, a change in capacitance was small even after elapse of the ten thousand cycles similarly to Comparative Examples 1 and 2. Therefore, it is recognized that the electric double layer capacitor according to the present invention has a high capacitance and also is excellent in life.

Due to the above, it is recognized that when the current collector according to the present invention is used in each electrode for a capacitor, it is possible to provide a capacitor that is excellent in capacity and durability as compared to an existing capacitor.

### REFERENCE SIGNS LIST

1 positive electrode
2 negative electrode
3 separator
4 organic electrolytic solution
5 case
6 lead wire
7 lead wire
20 electrode
21 active material
22 metal
23 metal film

1. An electrode material in which a metal is filled into pores in a surface portion at one surface of a powder molded body containing at least an active material powder and a metal film is formed on the one surface.

2. The electrode material according to claim 1, wherein the metal in the pores and the metal film on the one surface are formed by performing a plating treatment on the powder molded body.

3. An electric double layer capacitor comprising a positive electrode, a negative electrode, a separator located between the positive electrode and the negative electrode, and an electrolytic solution, wherein
each of the positive electrode and the negative electrode is composed of the electrode material according to claim 1 in which activated carbon is used as the active material powder.

4. The electric double layer capacitor according to claim 3, wherein the metal in each of the positive electrode and the negative electrode is aluminum.

5. A lithium ion capacitor comprising a positive electrode, a negative electrode, a separator located between the positive electrode and the negative electrode, and an electrolytic solution, wherein
the positive electrode is composed of the electrode material according to claim 1 in which activated carbon is used as the active material powder, and
the negative electrode is composed of the electrode material according to claim 1 in which a material capable of occluding and releasing lithium ions is used as the active material powder.

6. The lithium ion capacitor according to claim 5, wherein the active material of the negative electrode is caused to occlude lithium ions in advance.

7. The lithium ion capacitor according to claim 5, wherein
the metal in the positive electrode is aluminum, and
the metal in the negative electrode is copper.

8. A lithium secondary battery comprising a positive electrode, a negative electrode, a separator located between the positive electrode and the negative electrode, and an electrolytic solution, wherein
each of the positive electrode and the negative electrode is composed of the electrode material according to claim 1 in which a material capable of occluding and releasing lithium ions is used as the active material powder.

9. The lithium secondary battery according to claim 8, wherein
the metal in the positive electrode is aluminum, and
the metal in the negative electrode is copper.

10. The lithium secondary battery according to claim 8, wherein both the metal in the positive electrode and the metal in the negative electrode are aluminum.
